(19) United States
(12) Patent Application Publication
(10) Pub. No.: US 2025/0307394 A1
(43) Pub. Date: Oct. 2, 2025

(54) MIGRATING COMPROMISED WORKLOADS TO THREAT DETECTING COMPUTATIONAL STORAGE

(71) Applicant: INTERNATIONAL BUSINESS MACHINES CORPORATION, ARMONK, NY (US)

(72) Inventors: Evelyn Marie Perez, Winchester (GB); Eric John Bartlett, Chard (GB); Dominic Tomkins, Alton (GB); Miles Mulholland, Eastleigh (GB)

(21) Appl. No.: 18/618,826

(22) Filed: Mar. 27, 2024

(51) Int. Cl. G06F 21/55; G06F 21/56

(52) U.S. Cl. CPC G06F 21/554; G06F 21/56; G06F 2221/034

(57) ABSTRACT

Provided are techniques for migrating compromised workloads to threat detecting computational storage. A notification of a compromised workload is received from a threat detecting computational storage that identified a threat, wherein the threat detecting computational storage comprises compute capabilities on computational storage, and wherein one or more initial volumes of the compromised workload are stored on the computational storage. One or more additional volumes of the compromised workload stored on one or more storage devices are identified. One or more related volumes of the compromised workload stored on the one or more storage devices are identified. The one or more additional volumes and the one or more related volumes are migrated from the one or more storage devices to the computational storage. One or more uncompromised volumes on the computational storage are migrated to the one or more storage devices.

### BACKGROUND

Embodiments of the invention relate to migrating compromised workloads to threat detecting computational storage.

Data storage systems are usually designed to provide redundancy to reduce the risk of data loss in the event of failure of a component of the data storage system. Thus, a storage controller may store multiple copies of data on different storage devices, which may be geographically dispersed.

Computational storage may be described as a storage devices that have additional compute capabilities associated with them. The compute capabilities may be used for compression or deduplication operations, as well as other uses. For example, in one use case, the compute capabilities may be used to perform database operations against locally stored components of a table, which negates the need to stage the data into a server and process it there. Such operations against the data would previously be non-viable for the storage controller to perform.

Having the storage controller detect threats on storage devices may be time and resource consuming. For example, entropy checks via sampling incoming Input/Output (I/O) is relatively expensive, especially as these entropy checks become more sophisticated.

### SUMMARY

In accordance with certain embodiments, a computer program product comprising a computer readable storage medium having program code embodied therewith is provided, where the program code is executable by at least one processor to perform operations for migrating compromised workloads to threat detecting computational storage. In such embodiments, a notification of a compromised workload is received from a threat detecting computational storage that identified a threat, where the threat detecting computational storage comprises compute capabilities on computational storage, and where one or more initial volumes of the compromised workload are stored on the computational storage. One or more additional volumes of the compromised workload stored on one or more storage devices are identified. One or more related volumes of the compromised workload stored on the one or more storage devices are identified. The one or more additional volumes and the one or more related volumes are migrated from the one or more storage devices to the computational storage. One or more uncompromised volumes on the computational storage are migrated to the one or more storage devices.

In accordance with other embodiments, a computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for migrating compromised workloads to threat detecting computational storage. In such embodiments, a notification of a compromised workload is received from a threat detecting computational storage that identified a threat, where the threat detecting computational storage comprises compute capabilities on computational storage, and where one or more initial volumes of the compromised workload are stored on the computational storage. One or more additional volumes of the compromised workload stored on one or more storage devices are identified. One or more related volumes of the compromised workload stored on the one or more storage devices are identified. The one or more additional volumes and the one or more related volumes are migrated from the one or more storage devices to the computational storage. One or more uncompromised volumes on the computational storage are migrated to the one or more storage devices.

In accordance with yet other certain embodiments, a computer-implemented method comprising operations is provided for migrating compromised workloads to threat detecting computational storage. In such embodiments, a notification of a compromised workload is received from a threat detecting computational storage that identified a threat, where the threat detecting computational storage comprises compute capabilities on computational storage, and where one or more initial volumes of the compromised workload are stored on the computational storage. One or more additional volumes of the compromised workload stored on one or more storage devices are identified. One or more related volumes of the compromised workload stored on the one or more storage devices are identified. The one or more additional volumes and the one or more related volumes are migrated from the one or more storage devices to the computational storage. One or more uncompromised volumes on the computational storage are migrated to the one or more storage devices.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment with threat detecting computational storage in accordance with certain embodiments.

FIG. 3 illustrates, in a flowchart, operations by compute capabilities of the threat detecting computational storage in accordance with certain embodiments.

FIGS. 4A and 4B illustrate, in a flowchart, operations by a threat management system of a storage controller isolating a threat in accordance with certain embodiments.

FIG. 5 illustrates, in a flowchart, operations by the threat management system for identifying one or more related volumes in accordance with certain embodiments.

FIG. 6 illustrates, in a flowchart, operations by the threat management system for migrating compromised workloads to threat detecting computational storage in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

### EXAMPLES

The foregoing description provides examples of embodiments of the invention, and variations and substitutions may be made in other embodiments. Several examples will now be provided to further clarify various aspects of the present disclosure:

Example 1: A computer program product comprising a computer readable storage medium having program instructions embodied therewith, the program instructions executable by a processor to cause the processor to perform operations for receiving a notification of a compromised workload from a threat detecting computational storage that identified a threat, where the threat detecting computational storage comprises compute capabilities on computational storage, and where one or more initial volumes of the compromised workload are stored on the computational storage. The program instructions are executable by the processor to cause the processor to perform operations for identifying one or more additional volumes of the compromised workload stored on one or more storage devices. The program instructions are executable by the processor to cause the processor to perform operations for identifying one or more related volumes of the compromised workload stored on the one or more storage devices. The program instructions are executable by the processor to cause the processor to perform operations for migrating the one or more additional volumes and the one or more related volumes from the one or more storage devices to the computational storage. The program instructions are executable by the processor to cause the processor to perform operations for migrating one or more uncompromised volumes on the computational storage to the one or more storage devices.

Embodiments identify the one or more additional volumes of a compromised workload and the one or more related volumes of that compromised workload that are on storage devices. Then, embodiments advantageously migrate the identified volumes to the computational storage so that the compute capabilities may monitor the identified volumes for threats. In addition, embodiments advantageously migrate uncompromised volumes, that are not part of the compromised workload and are not related to the compromised workload, off of the computational storage to the storage devices. In this manner, embodiments advantageously isolate the one or more initial volumes of the compromised workload, the one or more additional volumes of the compromised workload, and the one or more related volumes of the compromised workload on the computational storage.

Example 2: The limitations of any of Examples 1 and 3-7, wherein the compute capabilities comprise hardware for performing operations on data stored on the computational storage.

Embodiments advantageously use threat detecting computational storage that comprises the compute capabilities comprising hardware for performing operations on data stored on the computational storage. This enables the compute capabilities to perform efficient monitoring of volumes stored on the computational storage.

Example 3: The limitations of any of Examples 1-2 and 4-7, wherein the program instructions are executable by the processor to cause the processor to perform operations for, in response to identifying the one or more additional volumes of the compromised workload and the one or more related volumes, selectively turning off tiering for the one or more initial volumes, the one or more additional volumes, and the one or more related, and, in response to determining that the threat is addressed, selectively turning on the tiering for the one or more initial volumes, the one or more additional volumes, and the one or more related volumes.

Embodiments advantageously turn off tiering of the one or more initial volumes, the one or more additional volumes, and the one or more related volumes to ensure that these volumes are not migrated off of the computational storage before the threat is addressed. Once the threat is addressed, embodiments advantageously turn on the tiering of the one or more initial volumes, the one or more additional volumes and the one or more related volumes so that these volumes on the computational storage may be moved to other storage devices for optimal performance.

Example 4: The limitations of any of Examples 1-3 and 5-7, wherein the program instructions are executable by the processor to cause the processor to perform operations for, in response to identifying the one or more additional volumes and the one or more related volumes, allocating additional storage capacity for the one or more additional volumes and the one or more related volumes on the computational storage.

Embodiments advantageously increase capacity to ensure that there is enough storage capacity to store the one or more additional volumes and the one or more related volumes.

Example 5: The limitations of any of Examples 1˜4 and 6-7, wherein the program instructions are executable by the processor to cause the processor to perform operations for placing a capacity limit for the one or more initial volumes, the one or more additional volumes, and the one or more related volumes on the computational storage and, in response to determining that the threat is addressed, removing the capacity limit for the one or more initial volumes, the one or more additional volumes, and the one or more related volumes on the computational storage.

The capacity limit advantageously ensures that the one or more initial volumes, the one or more additional volumes, and the one or more related volumes on the computational storage do not use up the storage space such that there is no storage space available for any non-compromised volumes on the computational storage. In addition, removing the capacity limit once the threat is addressed enables more efficient use of the computational storage.

Example 6: The limitations of any of Examples 1-5 and 7, wherein the one or more related volumes are identified using any combination of volume group details, volume copy information, pool membership, mapping information, and tiering correlations.

Embodiments advantageously identify the one or more related volumes using different techniques. This enables better capture of the one or more related volumes.

Example 7: The limitations of any of Examples 1-6, wherein the compute capabilities monitor the one or more initial volumes, the one or more additional volumes, and the one or more related volumes on the computational storage for threats.

Embodiments advantageously use the compute capabilities to monitor the one or more initial volumes, the one or more additional volumes, and the one or more related volumes on the computational storage for threats.

Example 8: A computer system comprising one or more processors, one or more computer-readable memories and one or more computer-readable, tangible storage devices, and program instructions, stored on at least one of the one or more computer-readable, tangible storage devices for execution by at least one of the one or more processors via at least one of the one or more computer-readable memories, to perform a method according to any of Examples 1-7.

Example 9: A computer-implemented method to perform a method according to any of Examples 1-7.

Example 10: The limitations of Examples 1 and 3, wherein embodiments advantageously, selectively turn off tiering to ensure that the migrated one or more additional volumes of the compromised workload and the one or more related volumes remain on the computational storage until the threat is addressed.

Example 11: The limitations of Examples 1 and 5, wherein embodiments advantageously identify the one or more related volumes using a combination of techniques to optimally find the one or more related volumes.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

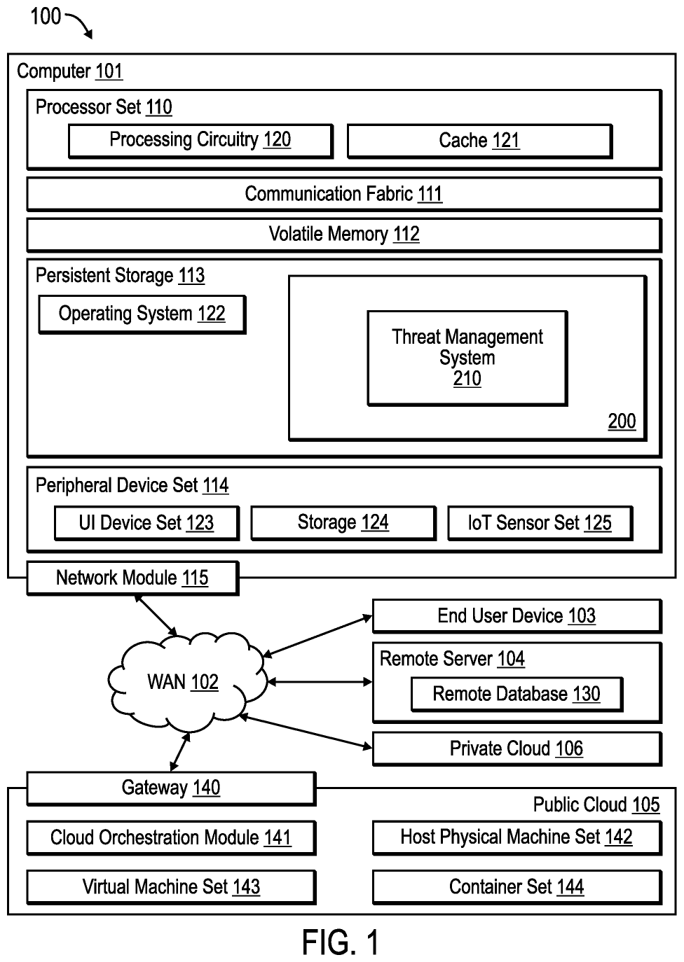

Computing environment 100 of FIG. 1 contains an example of an environment for the execution of at least some of the computer code involved in performing the inventive methods, such as a threat management system 210 of 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of

computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

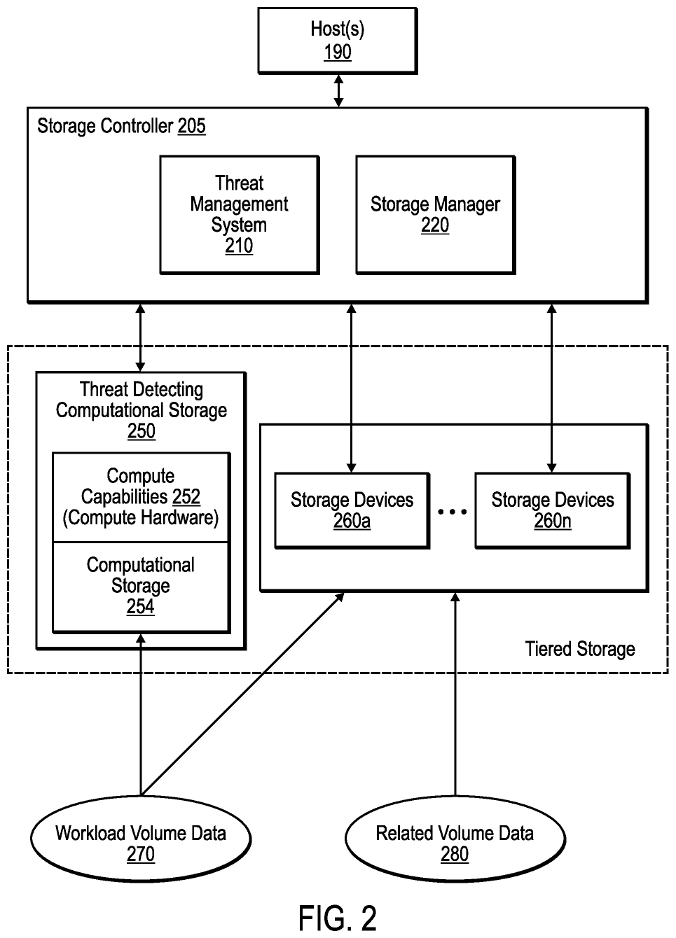

FIG. 2 illustrates a computing environment with threat detecting computational storage 250 in accordance with certain embodiments. A storage controller 205 includes a threat management system 210 and a storage manager 220. The storage controller 205 is connected to the threat detecting computational storage 250 and to other storage devices 260a . . . 260n (“non-computational” storage devices). In addition, the storage controller 205 is connected to one or more hosts 190. The one or more hosts 190 may initiate I/O operations (e.g., read and write operations) to the storage controller 205, and the storage controller 205 issues the I/O operations against the threat detecting computational storage 250 and/or the other storage devices 260a . . . 260n.

In certain embodiments, the storage controller 205 has the components of computer 101. In certain embodiments, the storage manager 220 manages storage operations, including data movement operations to and from the storage devices 250, 260a . . . 260n. The storage manager 220 performs migration on behalf of the threat management system 210.

In certain embodiments, the threat detecting computational storage 250 includes compute capabilities 252 on the computational storage 254. The compute capabilities 252 are implemented using compute hardware and perform operations against the data on the computational storage 254. The compute capabilities 252 are able to detect compromised data on the computational storage 254 that may indicate a threat from a threat actor (e.g., a cyberattack such as: phishing, ransomware, a malware attack, a data loss, etc.). The compute capabilities 252 may also be referred to as computational capabilities. The computational storage 254 may include one or more computational storage devices.

In certain embodiments, the threat detecting computational storage 250 is a FlashCore® Module (FCM), which is a sophisticated data storage medium. The FCMs combine high speed flash storage with sophisticated compute hardware to implement the compute capabilities (e.g., for compression of workloads, detection of ransomware signatures, etc.). (FlashCore and Flash are registered trademarks or common law marks of International Business Machines Corporation in the United States, other countries or both).

In certain embodiments, for one or more volumes (i.e., storing user data) and a host running applications against the one or more volumes, a workload may be described as a single instance of those applications running workloads against those volumes.

In certain embodiments, the storage devices 260a . . . 260n do not include compute capabilities.

In certain embodiments, the computational storage 254 and the other storage devices 260a . . . 260n form tiered storage with different types of storage devices in each of the tiers. For example, the threat detecting computational storage 250 is one tier, while the storage devices 260a . . . 260n form additional tiers. In certain embodiments, the computational storage 254 and the other storage devices 260a . . . 260n form storage arrays. Then, data may be moved to particular tiers for better performance in storing and retrieving that data. In certain embodiments, the computational storage 254 may be described as high performance storage, such as FCM, rather than a separate tier.

In certain embodiments, the computational storage 254 and the other storage devices 260a . . . 260n may be described as virtualized storage capacity, in which case the storage devices 260a . . . 260n are a mix of high performance flash, nearline drives, tape storage, and other types of storage. The computational storage 254 and other storage devices 260a . . . 260n may be cloud storage, on-premises storage, edge computing storage, etc.

In certain embodiments, the storage controller 205 stores data in a storage system that implements the threat detecting computational storage 250 in combination with the other storage devices 260a . . . 260n. The compute capabilities 252 of the threat detecting computational storage 250 identify a workload on the computational storage 254 that has been compromised and report this to the threat management system 210. Based on this, the threat management system 210 chooses to migrate data volumes associated with the compromised workload present on the other storage devices 260a . . . 260n to the computational storage 254 of the threat detecting computational storage 250. This allows the compute capabilities 252 of the threat detecting computational storage 250 to better monitor a given threat, reduces exposure to out-of-space conditions from encrypting workloads, and provides a better understanding of the scope of affected data.

In certain embodiments, migration describes moving data in the volumes (e.g., by allocating capacity on the computational storage 254, copying the data from the one or more storage devices 260a . . . 260n to the computational storage 254, and freeing up the capacity on the one or more storage devices 260a . . . 260n).

In certain embodiments, a workload may be described as one or more volumes, and the volumes of the workload may be referred to as workload volumes. In certain embodiments, the workload volume data 270 of the workload may initially be spread across the computational storage 254 and the storage devices 260a . . . 260n by the storage manager 220. In addition, related volume data 280 (i.e., related to the volumes of the workload) may be stored on the storage devices 260a . . . 260n. In certain embodiments, the storage manager 220 stores the workload volume data 270 and the related volume data 280 on the computational storage 254 for monitoring threats.

The threat detecting computational storage 250 has the capability to detect various threats (e.g., the signatures of ransomware activity). The threat detecting computational storage 250 detects entropy change observations that indicate a threat. In addition, the threat detecting computational storage 250 detects various types of threats using increasingly sophisticated approaches. The threat detecting computational storage 250 has non-trivial compute capabilities 252 that allow for this detection. As the checks (e.g., sampling capabilities) for threats become more sophisticated, the gulf between conventional detection at the storage controller 205 and the threat detecting computational storage 250 is increasing.

Moreover, certain embodiments optimally use threat detecting computational storage 250 within a heterogenous storage environment.

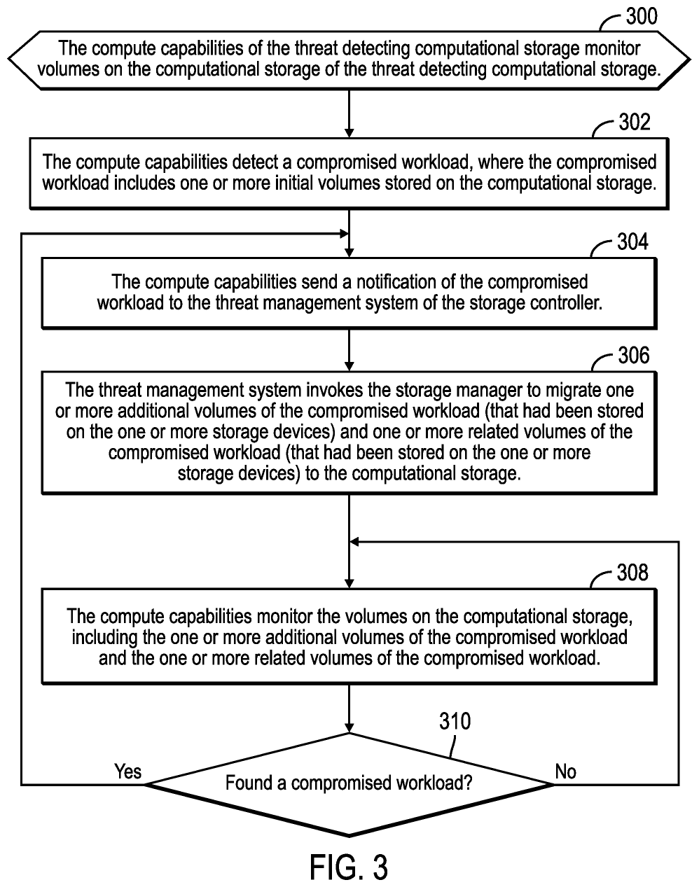

FIG. 3 illustrates, in a flowchart, operations by the compute capabilities 252 of the threat detecting computational storage 250 in accordance with certain embodiments. Control begins at block 300 with the compute capabilities 252 of the threat detecting computational storage 250 monitoring volumes on the computational storage 254 of the threat detecting computational storage 250.

In block 302, the compute capabilities 252 detect a compromised workload, where the compromised workload includes one or more initial volumes stored on the computational storage. A compromised workload may be described as one or more initial volumes stored on the computational storage 254 and one or more additional volumes stored on the storage devices 260a . . . 260n that may indicate a threat. That is, the volumes of a compromised workload may be spread across the computational storage 254 and the storage devices 260a . . . 260n.

In block 304, the compute capabilities 252 send a notification of the compromised workload to the threat management system 210 of the storage controller 205. In certain embodiments, the notification includes a drive Logical Block Address (LBA) range impacted, a duration of the threat, a type of the suspected threat (e.g., phishing, ransomware, a malware attack, a data loss, etc.), and a measure of confidence that this is a genuine threat. In certain embodiments, the threat management system 210 looks up the associated volume LBAs from the drive LBA range and records which of one or more volumes are impacted. Then, the threat management system 210 is able to associate the details of the threat (from the notification) with the compromised workload. In block 306, the threat management system 210 invokes the storage controller 220 to migrate one or more additional volumes of the compromised workload (that had been stored on the one or more storage devices 260a . . . 260n) and one or more related volumes (that had been stored on the one or more storage devices 260a . . . 260n) to the computational storage 254. In particular, the threat management system 210 identifies the one or more additional volumes of the compromised workload and the one or more related volumes on one or more storage devices 260a . . . 260n and migrates these to the threat detecting computational storage 250.

In block 308, the compute capabilities 252 monitor the volumes on the computational storage 254, including the one or more additional volumes of the compromised workload and the one or more related volumes of the compromised workload. At this time, the volumes of the compromised workload include the volumes that had already been stored on the computational storage 254 at the time the threat was detected and the volumes that had been stored on the one or more storage devices 260a . . . 260n and then were migrated to the computational storage 254.

In block 310, the compute capabilities 252 determine whether a compromised workload has been found based on the monitoring. If so, processing continues to block 304, otherwise, processing continues to block 308.

In certain embodiments, upon detection of a compromised workload by the threat detecting computational storage 250, the threat detecting computational storage 250 communicates this back to the storage controller 205, which is then able to manage the threat.

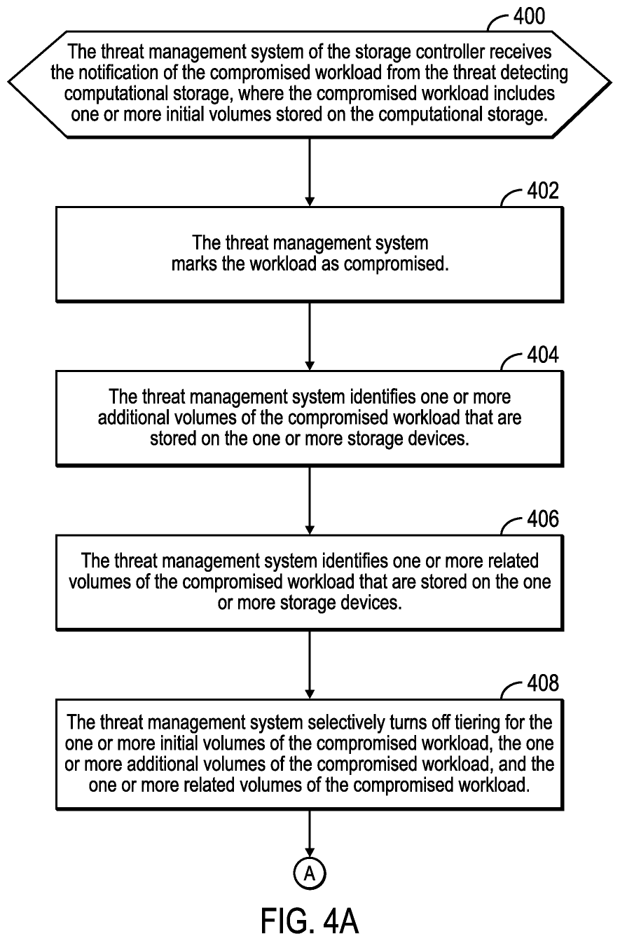

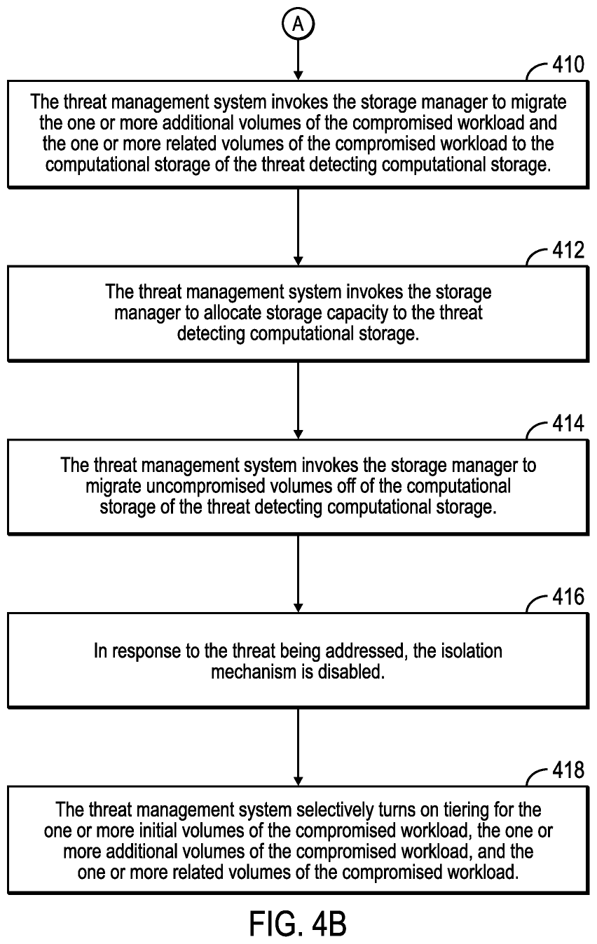

FIGS. 4A and 4B illustrate, in a flowchart, operations by a threat management system of a storage controller isolating a threat in accordance with certain embodiments. Control begins at block 400 (FIG. 4A) with the threat management system 210 of the storage controller 205 receiving the notification of the compromised workload from the threat detecting computational storage 250, where the compromised workload includes one or more initial volumes stored on the computational storage. In certain embodiments, the compute capabilities 252 of the threat detecting computational storage 250 sends the notification to the threat management system 210.

In block 402, the threat management system 210 marks (i.e., tags) the workload as compromised. In certain embodiments, the workload is marked by associating the details of the threat with the workload. In certain embodiment, the workload is unmarked once the threat has been addressed (e.g., by no longer associating the details of the threat with the workload). Addressing the threat may include resolving the threat. Once the threat has been addressed, the workload is no longer compromised.

In block 404, the threat management system 210 identifies one or more additional volumes of the compromised workload that are stored on the one or more storage devices 260a . . . 260n to identify the scope of the threat. The one or more additional volumes may be potentially compromised volumes.

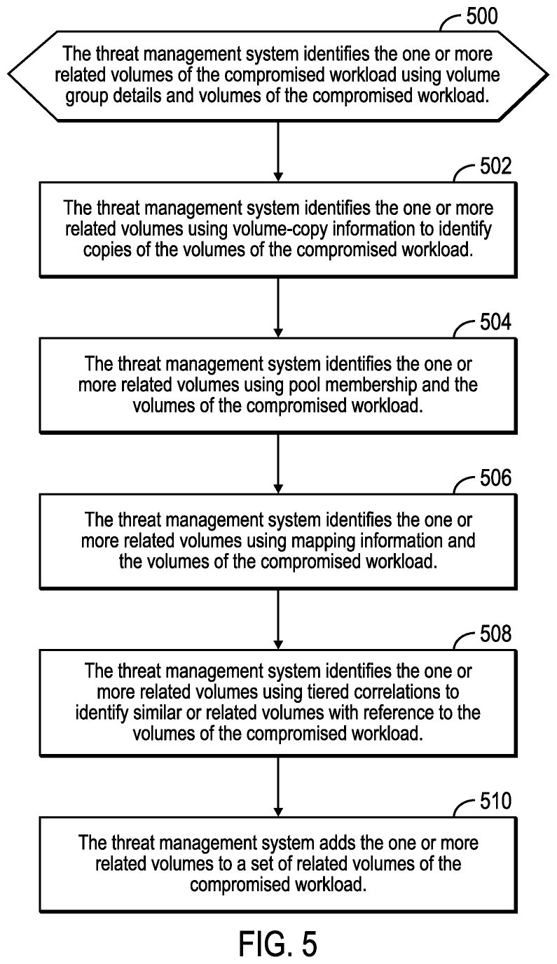

In block 406, the threat management system 210 identifies one or more related volumes of the compromised workload that are stored on the one or more storage devices 260a . . . 260n to identify the scope of the threat. FIG. 5 provides further details about identifying the one or more related volumes of the compromised workload. The one or more related volumes of the compromised workload may be potentially compromised volumes.

In block 408, the threat management system 210 selectively turns off tiering for the one or more initial volumes of the compromised workload, the one or more additional volumes of the compromised workload, and the one or more related volumes of the compromised workload. The volumes of the compromised workload include both one or more initial volumes of the compromised workload stored on the computational storage 254 and the one or more additional volumes of the compromised workload stored on the one or more storage devices 260a . . . 260n. The volumes of the compromised workload and the one or more related volumes of the compromised workload may be referred to as “compromised volumes”, while the volumes that are not part of or related to the compromised workload may be described as “non-compromised volumes”. From block 408 (FIG. 4A), processing continues to block 410 (FIG. 4B).

Tiering migrates volumes to different storage devices on different tiers to improve performance. In certain embodiments, the threat detecting computational storage 250 is part of tiered storage. Thus, before migrating the one or more additional volumes of the compromised workload and the one or more related volumes of the compromised workload to the threat detecting computational storage 250, the threat management system 210 turns off tiering for the one or more initial volumes of the compromised workload already on the computational storage 2550, the one or more additional volumes of the compromised workload and the one or more related volumes of the compromised workload to prevent these volumes from being moved off of the threat detecting computational storage 250. In certain embodiments, during the migration window, tiering for performance reasons of the data is selectively, functionally deactivated (i.e., turned off) to prevent demotion of the volumes of the compromised workload and the related volumes off of the threat detecting computational storage 250.

In certain embodiments, such as in the case of a severe threat, the storage controller 205 takes more complete control and uses the threat detecting computational storage 250 to keep up with the developing threat. In such cases, the one or more initial volumes of the compromised workload, the one or more additional volumes of the compromised workload, and the one or more related volumes of the compromised workload may be isolated on the computational storage 254.

In certain embodiments, the threat management system 210 decides to isolate the one or more initial volumes of the compromised workload, the one or more additional volumes of the compromised workload, and the one or more related volumes of the compromised workload, deactivates tiering on these volumes, and invokes the storage manager 220 to perform the migrations of the one or more additional volumes of the compromised workload and the one or more related volumes of the compromised workload from the storage devices 260a . . . 260n to the computational storage 254. Thus, in certain embodiments, the storage manager 220 performs the compromised workload volume data and related volume data placement and migration, while the threat management system 210 performs the tiering control.

In block 410, the threat management system 210 invokes the storage manager 220 to migrate the one or more additional volumes of the compromised workload and the one or more related volumes of the compromised workload to the computational storage 254 of the threat detecting computational storage 250. In certain embodiments, as part of migrating the one or more additional volumes and the one or more related volumes of the compromised workload, the storage manager 220 may perform operations such as copying or snapshotting, given that these volumes are going to be staged for the purpose of migration. In certain embodiments, the storage manager 220 migrates the one or more additional volumes and the one or more related volumes to a single storage array of the computational storage 254.

In block 412, the threat management system 210 invokes the storage manager 220 to allocate storage capacity to the threat detecting computational storage 250. For example, to move a volume from a source tier to a destination tier, the threat management system 210 invokes the storage manager 220 to check for sufficient storage on the destination tier to move the data from the source tier. If there is already sufficient space in the destination tier, then the storage manager 220 moves the volume to the destination tier. However, if there isn't sufficient space in the destination tier, then the storage manager 220 moves data out of the destination tier by migrating another volume's data to another tier, and then the storage manager 220 moves the volume to the destination tier.

In certain embodiments, the allocated storage capacity may be considered a high performance (“hot”), highly used (“highly subscribed”) tier, and not many volumes of the one or more related volumes are on this tier.

In block 414, the threat management system 210 invokes the storage manager 220 to migrate uncompromised volumes off of the computational storage 254 of the threat detecting computational storage 250. In certain embodiments, the threat management system 210 invokes the storage manager 220 to optionally migrate the volumes of unaffected workloads (i.e., volumes which are not compromised or uncompromised volumes) and capacity away from the threat detecting computational storage 250 to fully isolate the volumes of the compromised workload and the one or more related volumes of the compromised workload on the threat detecting computational storage 250. For example, if the computation storage devices 254 have 10 terabytes (10 TB) of capacity, with 9 TB full, and the threat management system 210 wants to move 5 TB of volumes onto the computation storage devices 254, then the threat management system 210 invokes the storage manager 220 to move 4 TB of data from the computation storage devices 254 to other storage devices 260a . . . 260n in order to fit that additional 5 TB.

In certain embodiments, in the event that sufficient storage capacity is available elsewhere (e.g., storage devices 260a . . . 260n) on the storage controller 205, the threat management system 210 may invoke the storage manager 220 to entirely vacate the threat detecting computational storage 250, except for the one or more related volumes of the compromised workload and the volumes of the compromised workload. In certain embodiments, the storage devices 260a . . . 260n may be selected based on preferences to keep performance for that data as similar as possible and selecting target storage devices 260a . . . 260n based on similar performance to the source storage devices 260a . . . 260n. Otherwise, in the event that there isn't sufficient storage capacity available elsewhere, the one or more related volumes of the compromised workload and the volumes of the compromised workload may be configured with a capacity limit (e.g., a secondary virtual/physical storage limit) on the threat detecting computational storage 250 to protect the other volumes (e.g., so that operations (e.g., encryption) are less likely to result in the storage array hitting an out-of-space event). In certain embodiments, there may be multiple capacity limits (e.g., one capacity limit on the volumes of the compromised workload and another capacity limit on the related volumes).

In certain embodiments, isolation is by storage type. In such embodiments, the one or more additional volumes of the compromised workload and the one or more related volumes of the compromised workload and (stored on the storage devices 260a . . . 260n) are migrated to the threat detecting computation storage 250, while the non-compromised volumes are migrated off of the threat detecting computation storage 250. This ensures that the compromised volume capacity does not consume capacity on the storage devices 260a . . . 260n that are storing non-compromised volumes.

In certain other embodiments, the isolation is by storage provisioning limits. In such embodiments, the one or more additional volumes of the compromised workload (stored on the storage devices 260a . . . 260n) and the one or more related volumes of the compromised workload are migrated to the threat detecting computation storage 250 and capacity limits are applied to the one or more initial volumes of the compromised workload, the one or more additional volumes of the compromised workload, and the one or more related volumes of the compromised workload stored on the computational storage 254. This limits the capacity consumption of the one or more initial volumes of the compromised workload, the one or more additional volumes of the compromised workload, and the one or more related volumes of the compromised workload stored on the computational storage 254, leaving sufficient capacity for the non-compromised volumes on the computational storage 254 of the threat detecting computation storage 250. In block 416, in response to the threat being addressed, the isolation mechanism is deactivated. In certain embodiments, once the threat has been addressed, a user or automated process may determine that the volumes are no longer considered compromised and deactivate the isolation mechanism. This allows tiering to begin to behave normally for the threat detecting computational storage 250 and removes any capacity limits (i.e., any the virtual/physical storage limits) for the one or more related volumes of the compromised workload affected in the threat detecting computational storage 250 once the threat is addressed.

In block 418, the threat management system 210 selectively turns on tiering for the one or more initial volumes of the compromised workload, the one or more additional volumes of the compromised workload, and the one or more related volumes of the compromised workload. The volumes of the compromised workload include both the one or more initial volumes of the compromised workload initially stored on the computational storage 254 and the one or more additional volumes migrated to the computational storage 254. This allows for these volumes to be migrated to and from the computational storage 254 of the threat detecting computational storage 250 for better performance.

In certain embodiments, the one or more additional volumes of the compromised workload and the one or more related volumes of the compromised workload remain on the computational storage 254 for some duration for elevated threat detection. However, eventually, the data before these volumes may be migrated per performance requirements to free up the high performance storage for use by other data. In certain embodiments, if the threat management system 210 is notified of new identified threats that result in new volumes being moved onto the computational storage 254, then data movement for those new identified threats take priority over previous threats that have been addressed.

FIG. 5 illustrates, in a flowchart, operations by the threat management system 210 for identifying one or more related volumes in accordance with certain embodiments. Control begins at block 500 with the threat management system 210 identifying one or more related volumes of the compromised workload on the storage devices 260a . . . 260n using volume group details and volumes of the compromised workload. A volume group may be described as a collection of related virtual volumes. The volume group is associated with the member volumes, and the member volumes are associated with the volume group. In certain embodiments, if a volume of the compromised workload is part of a volume group, then the threat management system 210 identifies other volumes in that group as related volumes. That is, the volume group details provides a hint as to what other volumes may also be affected by the threat. In certain embodiments, the threat management system 210 identifies one or more related volumes for the one or more initial volumes of the compromised workload stored on the computational storage 254 and the one or more additional volumes of the compromised workload to be migrated to the computational storage 254.

In block 502, the threat management system 210 identifies the one or more related volumes on the storage devices 260a . . . 260n using volume-copy information to identify copies of the volumes of the compromised workload. The volume-copy information identifies, for each volume, where copies of that volume are stored on the storage devices 260a . . . 260n. The volume-copy information may be a table, a list, a map or other memory construct. In certain embodiments, if a volume of a compromised workload on a computational storage 254 has copies stored on a storage device 260a . . . 260n, the threat management system 210 identifies the copies as related volumes.

In block 504, the threat management system 210 identifies one or more related volumes on the storage devices 260a . . . 260n using pool membership and the volumes of the compromised workload. A pool may be described as containing a set of capacity resources (managed disks) that provide capacity from (either external controller device Logical Unit Numbers (LUNs) or internal controller Redundant Array Of Independent Disks (RAID) arrays made from local internal drives. In certain embodiments, if a volume of a compromised workload on a computational storage 254 is part of a volume pool, then the threat management system 210 identifies other volumes in that volume pool as related volumes.

In block 506, the threat management system 210 identifies the one or more related volumes on the storage devices 260a . . . 260n using mapping information and the volumes of the compromised workload. The mapping information describes host-volume mappings, where the storage controller 205 manages host access to volumes via such mappings. When there is a compromised volume of a compromised workload, the threat management system 210 looks at the host mappings in order to determine which of one or more hosts may have sent such a compromised workload. Once the set of hosts are identified, the threat management system 210 looks at the host-volume mappings for those hosts in order to identify one or more other (i.e., related) volumes that the host is capable of sending workloads to.

In block 508, the threat management system 210 identifies the one or more related volumes using tiered correlations to identify similar or related volumes on the storage devices 260a . . . 260n with reference to the volumes of the compromised workload. In certain embodiments, if a volume of a compromised workload on a computational storage 254 has a tiered correlation to another volume, then the threat management system 210 identifies that other volume as a related volume. For example, if two sets of data are both being upgraded to hotter storage, that suggests that they are being accessed at the same time, and the threat management system 210 may infer that these are related pieces of data, regardless of which volume that those two pieces of data belong to. In particular, if there was a collection of log volumes and a database volume and there were heavy writes to the database volume, the threat management system 210 may infer that there is a heavy corresponding workload to the log volumes, and the log volumes and the database volumes are correlated. In certain embodiments, the threat management system 210 may correlate based on which extents are being upgraded from one tier to another. This may also be referred to as temporal locality (i.e., data accessed together frequently may be related).

In block 510, the threat management system 210 adds the one or more related volumes from blocks 500-508 to a set of related volumes of the compromised workload.

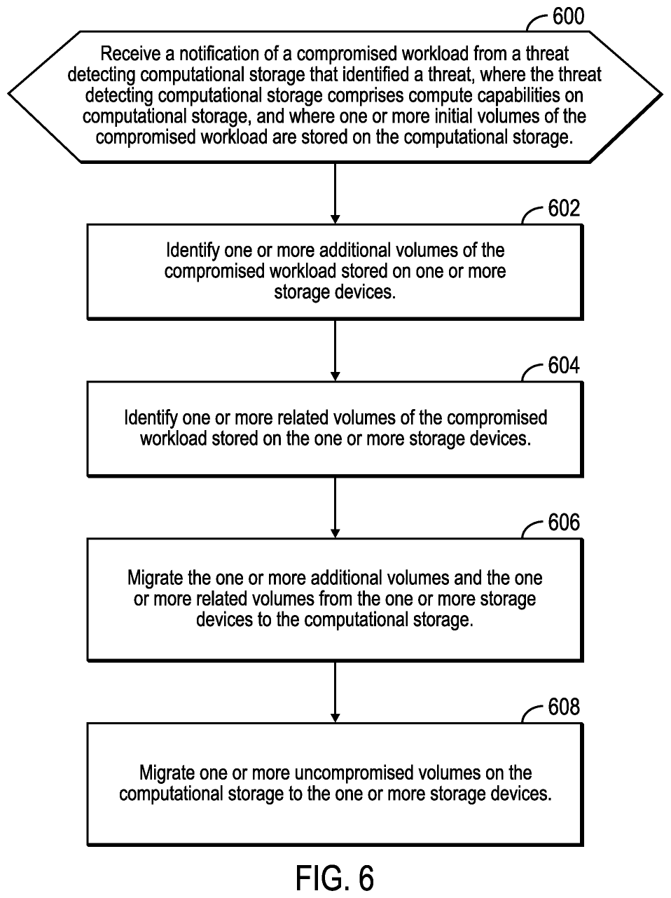

FIG. 6 illustrates, in a flowchart, operations by the threat management system 210 for migrating compromised workloads to threat detecting computational storage in accordance with certain embodiments. Control begins at block 600 with the threat management system 210 receiving a notification of a compromised workload from a threat detecting computational storage 250 that identified a threat, where the threat detecting computational storage 250 comprises compute capabilities 252 on computational storage 254, and where one or more initial volumes of the compromised workload are stored on the computational storage 254. In block 602, the threat management system 210 identifies one or more additional volumes of the compromised workload stored on one or more storage devices 260a . . . 260n. In block 604, the threat management system 210 identifies one or more related volumes of the compromised workload stored on the one or more storage devices 260a . . . 260n. In block 606, the threat management system 210 migrates the one or more additional volumes and the one or more related volumes from the one or more storage devices 260a . . . 260n to the computational storage 254. In block 608, the threat management system 210 migrates one or more other uncompromised volumes on the computational storage 254 to the one or more storage devices 260a . . . 260n. The uncompromised volumes are not volumes of the compromised workload and are not related to volumes of the compromised workload. That is, the uncompromised volumes are not associated with a threat.

In certain embodiments, the compute capabilities 252 comprise hardware for performing operations on data stored on the computational storage.

Thus, in certain embodiments, the threat management system 210 migrates a compromised workload to the threat detecting computational storage 250 by: detecting the compromised workload by the threat detecting computational storage 250; identifying other compromised volumes that are related to the compromised workload by the storage controller 205; and migrating these other compromised volumes to the threat detecting computational storage 250 while also allocating subsequent capacity for these volumes against the threat detecting tier and deactivating tiering. Optionally, the threat management system 210 migrates volumes of unaffected workloads and capacity away from the threat detecting computational storage 250 to isolate the compromised volumes. Moreover, the threat management system 210 re-activates (i.e., re-instantiates or turns-on) tiering and removes storage limits for the set of volumes affected in the threat detecting computational storage 250 once the threat has been addressed.

In certain embodiments, the threat management system 210 migrates compromised workloads onto the threat detecting computational storage 250 after initial detection in order to make the most of the computing capabilities 252 for detecting threats, as well as, performance characteristics of the computational storage devices 254, which may be implemented using high performance storage. In certain embodiments, the threat management system 210 evacuates workloads from the affected storage devices 260a . . . 260n or creates a quarantine pool to prevent out-of-space events affecting uncompromised workloads.

In certain embodiments, the threat management system 210 leverages tiering and information available to the storage controller 205 to make better use of the threat detecting computational storage 250. With embodiments, security event and incident management software benefit from the analysis of the affected volumes and from access to the threat detecting computational storage 250 (i.e., high performance storage) in order for further analysis to be performed.

In certain embodiments, the threat management system 210 is connected to threat detecting computational storage 250 in combination with other storage 260a . . . 260n, and the threat management system 210 determines that a workload has been compromised through use of the compute capabilities 252. Based on this, the threat management system 210 migrates volumes associated with the compromised workload that are present on the other storage 260a . . . 260n to threat detecting computational storage 250. With this migration, the threat detecting computational storage 250 is better able to monitor a given threat and reduce exposure to out-of-space conditions from encrypting workloads.

In addition, the threat management system 210 leverages the threat detecting computational storage 250 to understand and limit the scope of a compromised workload. In certain embodiments, the threat management system 210 reduces the time to analyze and recover data by restricting compromised workloads to a single storage array associated with the threat detecting computational storage 250. In certain embodiments, the threat management system 210 mitigates the risk of going out of space on conventional storage due to an encrypting workload by isolating this to the threat detecting computational storage 250. Moreover, the threat management system 210 uses the threat detecting computational storage 250 to detect risks to the environment through intelligent allocation.

Embodiments advantageously avoid leveraging systems entirely made out of threat detecting computational storage 250 as this may be expensive. Moreover, embodiments advantageously avoid problems associated with not isolating compromised workloads. For example, not isolating the compromised workloads may result in a system wide impact, whereas isolating the compromised workloads provides an opportunity to control and limit impact to the rest of the system.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product, the computer program product comprising a computer readable storage medium having program instructions embodied therewith, the program instructions executable by a processor to cause the processor to perform operations for:
receiving a notification of a compromised workload from a threat detecting computational storage that identified a threat, wherein the threat detecting computational storage comprises compute capabilities on computational storage, and wherein one or more initial volumes of the compromised workload are stored on the computational storage;
identifying one or more additional volumes of the compromised workload stored on one or more storage devices;
identifying one or more related volumes of the compromised workload stored on the one or more storage devices;
migrating the one or more additional volumes and the one or more related volumes from the one or more storage devices to the computational storage; and
migrating one or more uncompromised volumes on the computational storage to the one or more storage devices.

2. The computer program product of claim 1, wherein the compute capabilities comprise hardware for performing operations on data stored on the computational storage.

3. The computer program product of claim 1, wherein the program instructions are executable by the processor to cause the processor to perform further operations for:
in response to identifying the one or more additional volumes of the compromised workload and the one or more related volumes, selectively turning off tiering for the one or more initial volumes, the one or more additional volumes, and the one or more related volumes; and
in response to determining that the threat is addressed, selectively turning on the tiering for the one or more initial volumes of the compromised workload, the one or more additional volumes of the compromised workload, and for the one or more related volumes.

4. The computer program product of claim 1, wherein the program instructions are executable by the processor to cause the processor to perform further operations for:
in response to identifying the one or more additional volumes and the one or more related volumes, allocating additional capacity for the one or more additional volumes and the one or more related volumes on the computational storage.

5. The computer program product of claim 1, wherein the program instructions are executable by the processor to cause the processor to perform further operations for:
placing a capacity limit for the one or more initial volumes, the one or more additional volumes, and the one or more related volumes on the computational storage; and
in response to determining that the threat is addressed, removing the capacity limit for the one or more initial volumes, the one or more additional volumes, and the one or more related volumes on the computational storage.

6. The computer program product of claim 1, wherein the one or more related volumes are identified using any combination of volume group details, volume copy information, pool membership, mapping information, and tiering correlations.

7. The computer program product of claim 1, wherein the compute capabilities monitor the one or more initial volumes, the one or more additional volumes, and the one or more related volumes on the computational storage for threats.

8. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
receiving a notification of a compromised workload from a threat detecting computational storage that identified a threat, wherein the threat detecting computational storage comprises compute capabilities on computational storage, and wherein one or more initial volumes of the compromised workload are stored on the computational storage;
identifying one or more additional volumes of the compromised workload stored on one or more storage devices;
identifying one or more related volumes of the compromised workload stored on the one or more storage devices;
migrating the one or more additional volumes and the one or more related volumes from the one or more storage devices to the computational storage; and
migrating one or more uncompromised volumes on the computational storage to the one or more storage devices.

9. The computer system of claim 8, wherein the compute capabilities comprise hardware for performing operations on data stored on the computational storage.

10. The computer system of claim 8, wherein the program instructions further perform operations comprising:
in response to identifying the one or more additional volumes of the compromised workload and the one or more related volumes, selectively turning off tiering for the one or more initial volumes, the one or more additional volumes, and the one or more related volumes; and
in response to determining that the threat is addressed, selectively turning on the tiering for the one or more initial volumes of the compromised workload, the one or more additional volumes of the compromised workload, and for the one or more related volumes.

11. The computer system of claim 8, wherein the program instructions further perform operations comprising:
in response to identifying the one or more additional volumes and the one or more related volumes, allocating additional capacity for the one or more additional volumes and the one or more related volumes on the computational storage.

12. The computer system of claim 8, wherein the program instructions further perform operations comprising:
placing a capacity limit for the one or more initial volumes, the one or more additional volumes, and the one or more related volumes on the computational storage; and
in response to determining that the threat is addressed, removing the capacity limit for the one or more initial volumes, the one or more additional volumes, and the one or more related volumes on the computational storage.

13. The computer system of claim 8, wherein the one or more related volumes are identified using any combination of volume group details, volume copy information, pool membership, mapping information, and tiering correlations.

14. The computer system of claim 8, wherein the compute capabilities monitor the one or more initial volumes, the one or more additional volumes, and the one or more related volumes on the computational storage for threats.

15. A computer-implemented method, comprising operations for:
receiving a notification of a compromised workload from a threat detecting computational storage that identified a threat, wherein the threat detecting computational storage comprises compute capabilities on computational storage, and wherein one or more initial volumes of the compromised workload are stored on the computational storage;
identifying one or more additional volumes of the compromised workload stored on one or more storage devices;
identifying one or more related volumes of the compromised workload stored on the one or more storage devices;
migrating the one or more additional volumes and the one or more related volumes from the one or more storage devices to the computational storage; and
migrating one or more uncompromised volumes on the computational storage to the one or more storage devices.

16. The computer-implemented method of claim 15, wherein the compute capabilities comprise hardware for performing operations on data stored on the computational storage.

17. The computer-implemented method of claim 15, further comprising operations for:
in response to identifying the one or more additional volumes of the compromised workload and the one or more related volumes, selectively turning off tiering for the one or more initial volumes, the one or more additional volumes, and the one or more related volumes; and
in response to determining that the threat is addressed, selectively turning on the tiering for the one or more initial volumes of the compromised workload, the one or more additional volumes of the compromised workload, and for the one or more related volumes.

18. The computer-implemented method of claim 15, further comprising operations for:
in response to identifying the one or more additional volumes and the one or more related volumes, allocating additional capacity for the one or more additional volumes and the one or more related volumes on the computational storage.

19. The computer-implemented method of claim 15, further comprising operations for:
placing a capacity limit for the one or more initial volumes, the one or more additional volumes, and the one or more related volumes on the computational storage; and
in response to determining that the threat is addressed, removing the capacity limit for the one or more initial volumes, the one or more additional volumes, and the one or more related volumes on the computational storage.

20. The computer-implemented method of claim 15, wherein the one or more related volumes are identified using any combination of volume group details, volume copy information, pool membership, mapping information, and tiering correlations.
